(19) United States
(12) Patent Application Publication
(10) Pub. No.: US 2026/0336249 A1
(43) Pub. Date: Oct. 29, 2026

(54) A MACHINE FOR SUPPLYING CORRUGATED CARDBOARD TO A MACHINE FOR BOXING OR PACKAGING ARTICLES USING CORRUGATED CARDBOARD, A MACHINERY AND METHODS

(71) Applicant: C.M.C S.P.A, CERBARA-CITTA'DI CASTELLO(PG) (IT)

(72) Inventor: Francesco PONTI, CITTA’DI CASTELLO(PG) (IT)

(73) Assignee: C.M.C S.P.A, CERBARA-CITTA'DI CASTELLO(PG) (IT)

(21) Appl. No.: 19/490,348

(22) PCT Filed: Jun. 14, 2024
(86) PCT No.: PCT/IB2024/055830

§ 371 Date: Dec. 4, 2025

(30) Foreign Application Priority Data
Jun. 14, 2023 (IT) 102023000012165

(51) Int. Cl. B31F 1/28; B65B 43/08

(52) U.S. Cl. CPC B31F 1/2818; B31F 1/2831; B31F 1/285; B31F 1/2881; B65B 43/08; B65B 2210/04

(57) ABSTRACT

A machine for realising corrugated cardboard, comprising unwinders of reels for unwinding strips, a glue dispenser, a press, strips paths and a control unit. The first path or the second path crosses the glue dispenser so that the glue is interposed between the first strip and the second strip before they are pressed and drawn by a first press belt and a second press belt or by a first press belt, a first press roller and a second press roller which the control unit stops and restarts when a length is provided on the basis of successive values of the desired length of corrugated cardboard received by the control unit. Machinery comprising the machine and a machine for boxing or packaging articles and methods.

### FIELD OF THE INVENTION

The present invention concerns the technical sector relating to the production of corrugated cardboard sheets starting from reels of cardboard and in the sector of making boxes or packaging made of corrugated cardboard to package articles, i.e. for boxing one or more articles or to package one or more articles with packaging cardboard. The invention relates to a machine for realising strips or sheets of corrugated cardboard, for boxing or for packaging articles using corrugated cardboard, and a machinery for boxing or packaging and relative operating methods. In greater detail, the present invention concerns a machine for supplying corrugated cardboard to a machine, for boxing or packaging articles, typically sheets of single-wall corrugated cardboard but, potentially, also single-face corrugated cardboard.

### DESCRIPTION OF THE PRIOR ART

In the present description, by simple corrugated cardboard, also known as single-wall corrugated cardboard, is meant a cardboard with two external layers of cardboard, typically smooth between which is interposed a corrugated layer of cardboard while by the term single-face corrugated cardboard is meant a cardboard having two layers: one corrugated layer of cardboard and a layer of cardboard that is typically smooth. By way of example, FIG. 1 shows a corrugated layer of cardboard, FIG. 2 shows a layer of smooth cardboard and a corrugated layer of cardboard with the crests facing towards the layer of smooth cardboard being covered with glue and FIG. 3 shows a corrugated layer of cardboard interposed between two layers of smooth cardboard with the crests covered with glue, for example vinyl glue and/or hot melt adhesive.

It is known to realise single-wall corrugated cardboard, or single face starting from reels of smooth cardboard by means of systems or lines which extend horizontally for tens of metres. Like solutions, which exploit the deploying of cardboard strips with the aim of ensuring production velocity and good manufacturing, are suitable for continuous productions and/or for productions of large batches, but are difficult to integrate into an industrial facility upstream of one or more machines for packaging articles owing to the dimensions, as well as the cost. Examples of like devices are described in EP0146441B1 and in EP2460651A1.

Document FR362835A illustrates a coupling machine for realising single-wall corrugated cardboard starting from a first reel of single-face corrugated cardboard and a second reel of smooth cardboard.

Also known is a machine, described in GB132725A, which is not arranged in-line and which integrate a reel of single-face corrugated cardboard starting from a first reel and a second reel of smooth cardboard; this reel is positioned in elevation and the cardboard passes through corrugator rollers with application of glue on the crests before being coupled with the smooth cardboard coming from the other reel.

The cardboard products obtained with the cited machines and other known machines, whether sheets, reels, fanfolds, blanks or flat boxes to be formed, are transported to the facility in which the machinery for boxing articles is installed, arrranged inside one or more stores, and then collected for the formation of the box or packaging.

The need to reduce the size of the boxes and/or the consumption of cardboard, has led to the introduction of machineries that form the boxes on the basis of the article or the articles that each cardboard box or packaging must contain or which directly wrap the article or articles with packaging cardboard.

Document EP2890554A1 describes a method and a machinery for packaging articles starting from a continuous cardboard strip. The cardboard strip is stored in appropriate reels or in continuous sheets of corrugated cardboard folded in a bellows fashion, known by the term fanfold, as mentioned in the foregoing. The cardboard strip unwound from the reel or extracted from a fanfold is cut and scored on the basis of dimensions of the article or articles.

Document EP3867053A1 illustrates a machine that can be used upstream of a machinery for packaging articles and which integrate a cardboard strip by consecutively joining cardboard sheets to one another.

Documents EP3947167A1, EP3464074A1 and EP4117995A1 illustrate machineries and methods for boxing articles starting from strips or fanfolds.

Document EP4157726A1 describes a packaging machine which wraps a strip about articles to form envelopes containing articles.

Document EP3947166A1 illustrates and concerns methods, machines and machineries for realising boxes starting from a cardboard die-cut blanks and for boxing a plurality of articles.

Document WO2023002396A1 describes a machinery and a method for adapting boxes to be formed to the respective contents.

The management of reels made of single-wall corrugated cardboard, such as fanfolds or boxes to be formed, is economically especially punitive and/or requires an attentive and/or continuous provision and/or leads to significant occupation of spaces, in both the store and during transport, due to the volume of the empty spaces in the corrugated cardboard as a result of the corrugations.

Further, in the case of fanfolds, the package realised can have some undesired folds coinciding with the original folds of the “bellows”; folds such as these are not aesthetically appealing and/or weaken the package itself, to the point of determining a poorer protection for the contents. In the case of the boxes to be formed, the dimensions of the base can be customised only via discrete operating steps, by sourcing the boxes to be formed from a selection of stores.

Document WO20141 19439A1 of a machinery for boxing or packaging articles using corrugated cardboard, which starts from the making of a blank from a plurality of strips coming from respective reels and which transports the blank under formation on conveyor means comprising a roller conveyor.

Document WO2014119439A1, as well as document US2018117870A1, describes the use of press rollers for joining to one another the superposed layers of corrugated cardboard. However it is not clear from these two documents how it is possible to realise a corrugated cardboard of high quality with a machine of modest dimensions and with continuous stops in production, not provided for and difficult to manage in the case of the machines described in EP0146441B1 and in EP2460651A1. There is therefore an established need for a machine having these characteristics, especially since the Applicant is not aware of the market offer of a machinery alike to the one described in WO2014119439A1.

### SUMMARY OF THE INVENTION

The present invention intends to obviate one or more drawbacks of the solutions of the prior art. A first aim of the present invention is to provide a machine that can make, on request, corrugated cardboard, preferably corrugated cardboard sheets, more preferably single-wall corrugated cardboard sheets.

A second aim of the present invention is to provide a compact machine.

A third aim of the invention is to reduce the volume of the stores of cardboard products and/or to simplify and/or to make the provision of the corrugated cardboard more economical.

A further aim of some embodiments is to ensure a high quality of corrugated cardboard even in the case of intermittent production, for example in order to follow the requests of a machine downstream.

A still further aim of some embodiments of the present invention is to facilitate the customisation of the packaging of the articles so as to reduce the volume of the packages and/or the consumption of material.

These and other aims, which will be obvious to the expert in the sector from a reading of the following text, are attained by means of a machine for supplying corrugated cardboard to a machine for boxing or packaging articles according to the invention, of a machinery for boxing or packaging articles using corrugated cardboard, of a method for providing single-wall corrugated cardboard sheets to a machine for boxing or packing articles or of a method for operating a machinery for boxing or packaging articles using corrugated cardboard according to the contents of the claims.

According to the teachings of the present description, the machine comprises:
a first reel unwinder for unwinding a first strip from a first reel of cardboard;
a second reel unwinder for unwinding a second strip from a second reel of cardboard;
a glue dispenser for depositing adhesive on a side of cardboard strip;
a press for pressing strips and drawing strips according to a drawing direction comprising a first press belt;
a first path of the first strip which, going from the first unwinder, reaches the press;
a second path of the second strip which, going from the second unwinder, reaches the press;
a control unit which controls the press.

Further:
the first path or the second path crosses the glue dispenser so that the glue dispenser deposits glue on the first strip or on the second strip;
the first path and the second path meet before or at the press so that the glue is interposed between the first strip and the second strip;
the press comprises a second press belt located above the first press belt or a first press roller and a second press roller which are positioned above the first press belt and which are spaced apart from one another in the drawing direction so that the first press belt and the second press belt or the first press belt and the first press roller and the first press belt and the second press roller press one another and together draw, in the drawing direction, the first strip and the second strip, thus forming corrugated cardboard;
the control unit is configured to receive successive values of the desired length of corrugated cardboard and to stop and restart the first press belt and the second press belt, the first press roller and the second press roller each time a desired length of corrugated cardboard is supplied in outlet from the press.

According to the teachings of the present description, the machinery comprises:
a machine for supplying corrugated cardboard according to the present description;
a machine for boxing or packing articles which comprises a corrugated cardboard inlet.

The corrugated cardboard inlet is arranged downstream of the machine for supplying corrugated cardboard so as to receive corrugated cardboard sheets or strips.

According to the teachings of the present description the method for providing single-wall corrugated cardboard sheets to a machine for boxing or packing articles comprises steps of:
providing a machine for supplying corrugated cardboard according to the present description;
supplying a first strip of smooth cardboard;
supplying a second strip of single-face corrugated cardboard;
receiving a first value of a desired length of a corrugated cardboard sheet;
starting the press, starting the first press belt and the second press belt or starting the first press belt, the first press roller and the second press roller;
stopping the press, stopping the first press belt and the second press belt or stopping the first press belt, the first press roller and the second press roller after the first strip and the second strip are advanced in the drawing direction for a distance equal to the first value;
cutting the corrugated cardboard in outlet from the press so as to obtain a single-wall corrugated cardboard sheet.

According to the teachings of the present description, the method for operating the machinery comprises steps of:
providing one or more articles;
providing a cutter, for cutting corrugated cardboard strips so as to obtain corrugated cardboard sheets;
providing a machinery for boxing or packaging articles using corrugated cardboard according to the present description and wherein the control unit controls the cutter so that the cutter cuts corrugated cardboard sheets having a desired length with the press stopped;
determining at least one dimension of a box or a packaging made of corrugated cardboard for containing or winding the one or more articles;
defining a value of the desired length of a corrugated cardboard sheet on the basis of at least one dimension;
transmitting the value to the control unit.

### BRIEF DESCRIPTION OF THE DRAWINGS

Specific embodiments of the invention will be described in the following part of the present description, according to what is set down in the claims and with the aid of the accompanying figures, in which:

FIG. 1 is a schematic view of a corrugated layer;

FIG. 2 is a schematic view of layers which form a single-face corrugated cardboard;

FIG. 3 is a schematic view of layers which form a single-wall corrugated cardboard;

FIG. 4 is a view of an embodiment of a machine for supplying corrugated cardboard to a machine for boxing or packaging articles according to the invention;

FIG. 5 is a section view of FIG. 4, passing through the median plane of the unwinding rollers, which enables an appreciation of the functioning of the machine;

FIG. 6 is a view of the embodiment of FIG. 4, from a different viewpoint;

FIG. 7 is a view of some components of the embodiment of FIG. 4;

FIG. 8 is a view of some components of the embodiment of FIG. 4;

FIG. 9 is a view of a schematic portion of a modified embodiment of the embodiment of FIG. 4;

FIG. 10 is a view of a portion of a modified embodiment of that of FIG. 4;

FIG. 11 is a view of the machine of FIG. 4 provided of the portion of FIG. 10 with some elements removed to show the relevant parts for the present document;

FIG. 12 is a section view of FIG. 13, passing through the median plane of the unwinding rollers, which enables an appreciation of the functioning of the machine;

FIG. 13 is a view of a further embodiment of a machine for supplying corrugated cardboard to a machine for boxing or packaging articles according to the invention;

FIG. 14 is a view of the detail of the machine of FIG. 13 with some elements not illustrated in order to enable a view of the internal components;

FIG. 15 is a view of a detail of the machine of FIG. 13 with some elements not illustrated in order to enable a view of the internal components;

FIG. 16 is a section view of FIG. 17, passing through the median plane of the unwinding rollers, which enables an appreciation of the functioning of the machine;

FIG. 17 is a view of a still further embodiment of a machine for supplying corrugated cardboard to a machine for boxing or packaging articles according to the invention;

FIG. 18 is a view of a detail of the machine of FIG. 17 with some elements not illustrated to enable a view of the internal components;

FIG. 19 is a central detail of FIG. 16;

FIG. 20 is a view of a detail of showing a technology of a glue dispenser alternative to the machine of FIG. 17 and to that of the machine of FIG. 4;

FIG. 21 is a view of a detail of showing the technology of FIG. 20 positioned differently with respect to FIG. 20, so as to operate on another strip;

FIG. 22 is a view of a detail showing the technology of FIG. 20 applied at a successive point of the machine;

FIG. 23 is a view of a detail of showing the technology of FIG. 20 applied at a successive point of the machine positioned differently with respect to FIG. 22, so as to operate on another strip;

FIG. 24 illustrates an embodiment of a machinery for boxing or packaging articles with corrugated cardboard according to the invention;

FIG. 25 illustrates a further embodiment of a machinery for boxing or packaging articles using corrugated cardboard according to the invention.

### DESCRIPTION OF THE PREFERRED EMBODIMENTS

With reference to the appended figures, reference numeral 10 denotes a machine for supplying corrugated cardboard to a machine (100) for boxing or packaging articles (P).

The references are reported to facilitate understanding of the invention, but are not intended to limit the scope of the invention.

An embodiment of the machine (10) comprises:
a first reel unwinder (1) for unwinding a first strip (N1) from a first reel (B1) of cardboard;
a second reel unwinder (2) for unwinding a second strip (N2) from a second reel (B2) of cardboard;
a glue dispenser (4) for depositing glue (A) on a side of cardboard strip;
a press (5) for pressing strips and drawing strips according to a drawing direction (T) which comprises a first press belt (51);
a first path (11) of the first strip (N1) which, going from the first unwinder (1), reaches the press (5);
a second path (12) of the second strip (N2) which, going from the second unwinder (2), reaches the press (5);
a control unit (10a) which controls the press (5).

A path, between the first path (11) and the second path (12), crosses the glue dispenser (4) so that the glue dispenser (4) deposits glue (A) on the first strip (N1) or on the second strip (N2);

The first path (11) and the second path (12) meet before or at the press (5) so that the glue (A) is interposed between the first strip (N1) and the second strip (N2).

The press (5) comprises a second press belt (52) located above the first press belt (51) or a first press roller (53) and a second press roller (54) which are positioned above the first press belt (51) and which are spaced apart from one another in the drawing direction (T) so that the first press belt (51) and the second press belt (52) press one another and together draw, in the drawing direction (T), the first strip (N1) and the second strip (N2), thus forming corrugated cardboard or the first press belt (51) and the first press roller (53) and the first press belt (51) and the second press roller (54) press one another and together draw, in the drawing direction (T), the first strip (N1) and the second strip (N2), thus forming corrugated cardboard.

The control unit (10a) is configured to receive successive values of the desired length of corrugated cardboard and to stop and restart the first press belt (51) and the second press belt (52) or to stop and restart the first press belt (51), the first press roller (53) and the second press roller (54) each time a desired length of corrugated cardboard is supplied in outlet from the press (5).

The machine (10) described in the foregoing can make corrugated cardboard, i.e. corrugated cardboard strips and/or corrugated cardboard sheets, on request and according to needs, thus facilitating the provision of machines for boxing or packaging articles (P) using corrugated cardboard.

For example, the machine (10) enables production of a succession of three or more corrugated cardboard sheets (F) with each corrugated cardboard sheet (F) having a length (L) that is different from the previous one and from the following one.

The stop and restart between a first corrugated cardboard sheet (F) and a second corrugated cardboard sheet (F) enables cutting the corrugated cardboard sheets (F) from corrugated cardboard strips that are not in movement and, more preferably, again arranged horizontally or slightly inclined, i.e. without storage paths downstream of the press (5) which might negatively influence the quality of the product. Further, this enables respecting the time requirements imposed from downstream, for example from a machine (100) for boxing or packaging articles (P), as in the machinery (1000) of the invention.

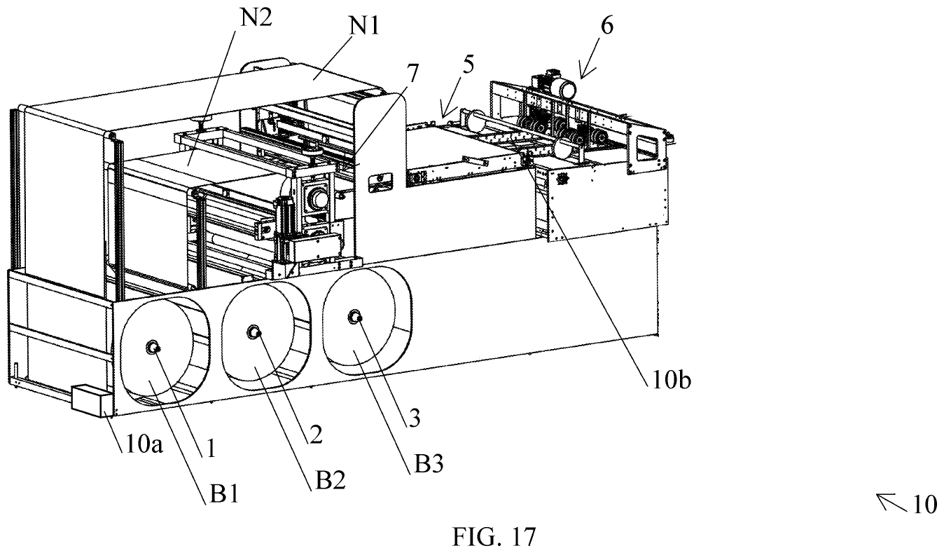

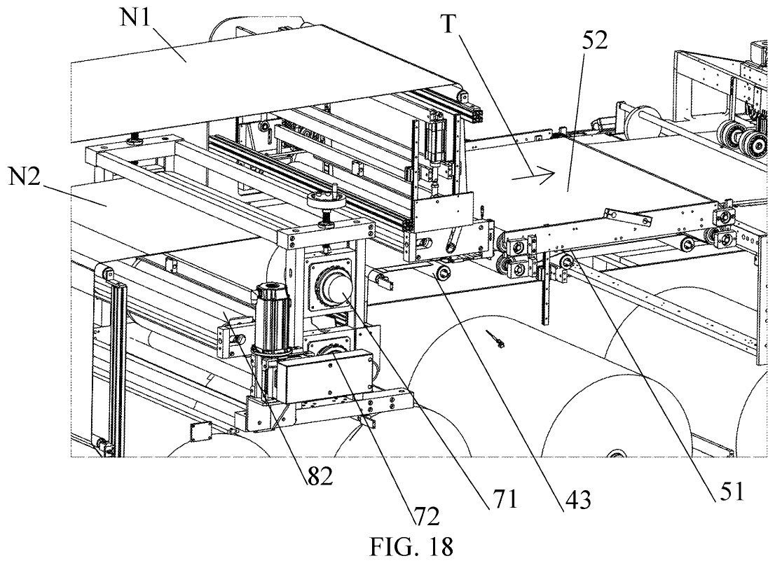

The press (5) enables drawing the adjacent strips at the same velocity due to a pressure which, in the embodiment of FIG. 17, is determined by the distance between a first press belt (51) and a second press belt (52), moved by respective rollers. This pressure also enables homogenising the layering so as to obtain a corrugated cardboard of high quality.

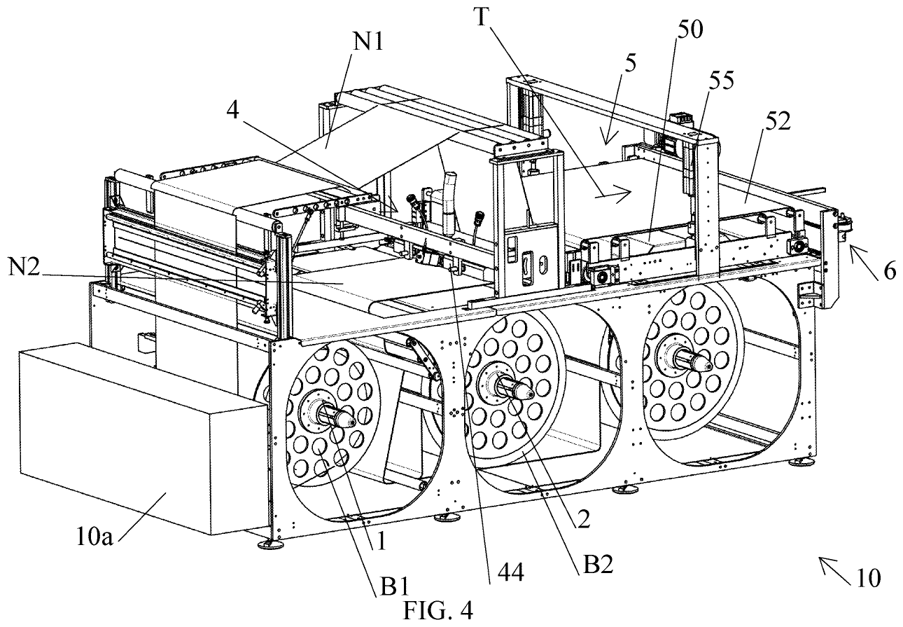

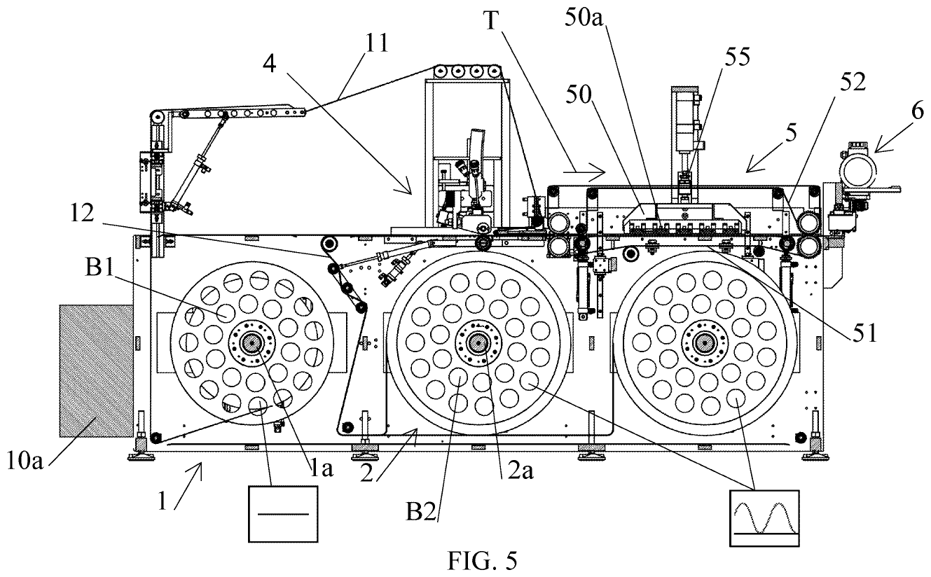

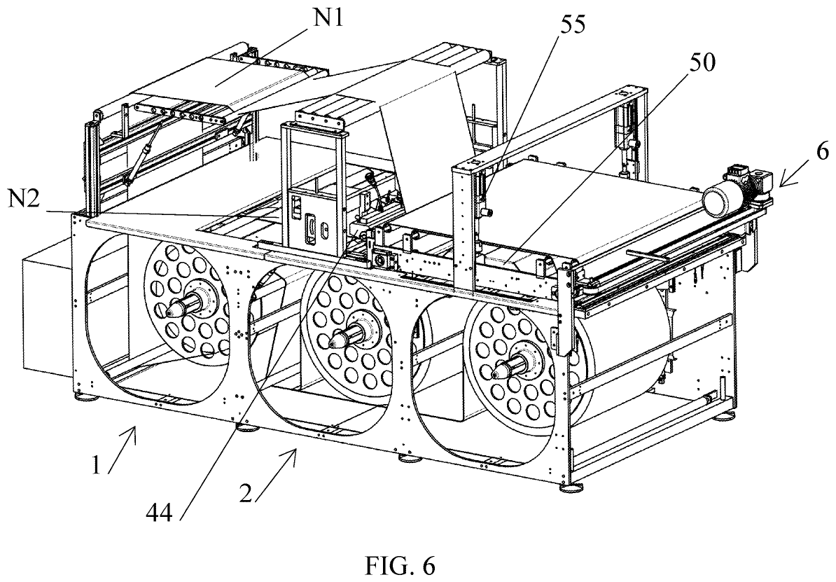

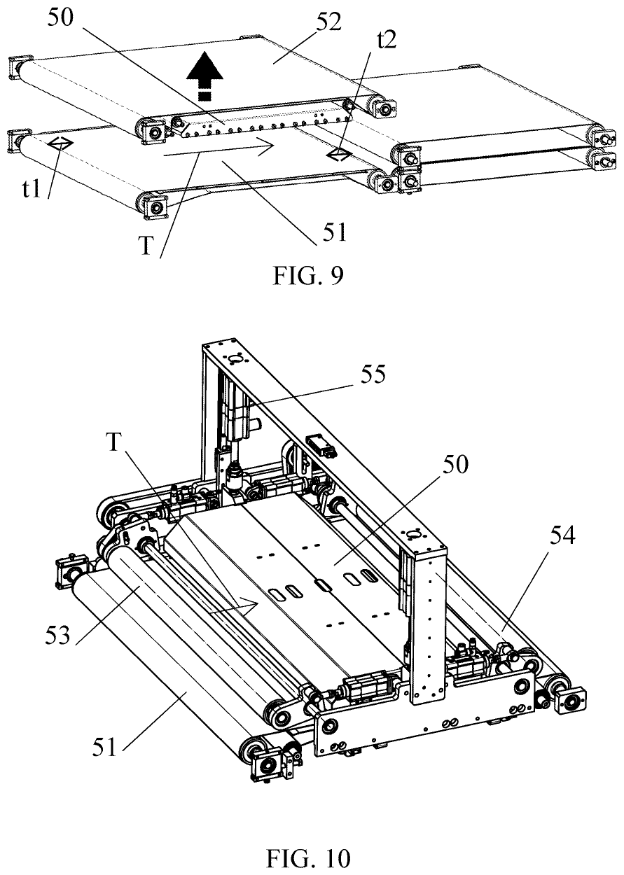

In the embodiments of FIG. 4 and FIG. 9 the second press belt (52) does not press or draw together the first press belt (51) over the whole length thereof but only for a first portion (t1) and for a second portion (t2).

In the embodiment of FIG. 10 the upper press belt, i.e. the second press belt (52), is replaced with a first press roller (53) and with a second press roller (53) spaced apart from one another in the drawing direction (T) so as to determine an effect alike to that of FIG. 4 and FIG. 9.

As will emerge clearly from the reading of the following description, the embodiments of FIG. 4, of FIG. 9 and of FIG. 10 facilitate the arrangement of a heater (50) in a particularly efficient and effective way.

The presence of a press (5) in the terms illustrated above and of a control unit (10a) that controls it in such a way as to stop and restart the production enables cutting the corrugated cardboard formed which can take place on the same machine (10) or on a machine downstream thus obtaining a corrugated cardboard sheet (F) of the desired length (L). Further, the above-described configurations enable maintaining a good level of quality of the corrugated cardboard with respect to what is realisable with the machines described in WO2014119439A1 or US2018117870A1.

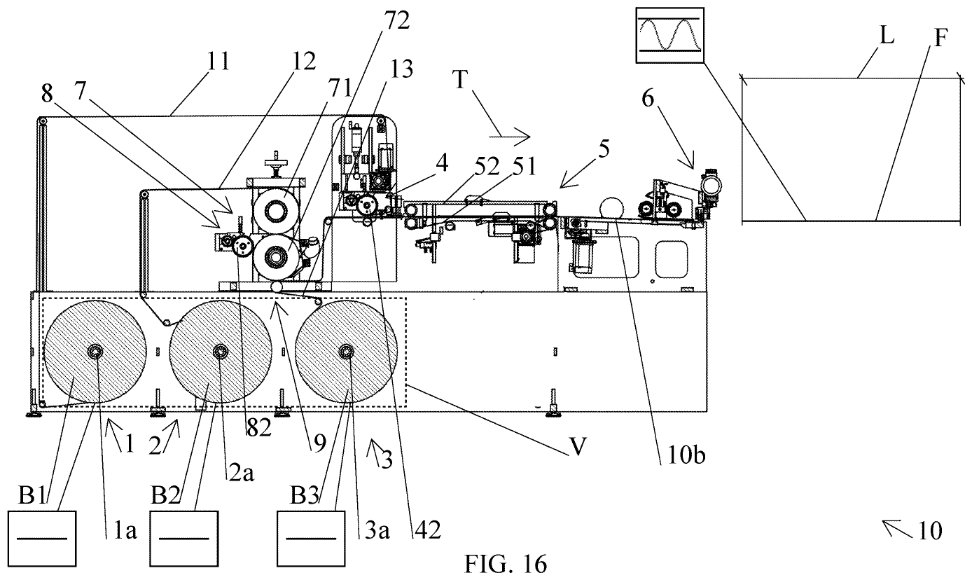

In greater detail, as illustrated by way of example in FIG. 16, the press (5) can comprise a first press belt (51) and a second press belt (52) opposite and distanced so as to press and reciprocally move the first strip (N1), the second strip (N2) and the third strip (N3). Typically the first press belt (51) and the second press belt (52) engage respective rollers, with at least one of these being motorised or set in rotation by a motor, typically electrically powered. The control of the respective motorised roller or rollers and/or of the motor or motors enables the stop and restart of the first press belt (51) and of the second press belt (52) so as to enable the stopping and restarting of the production of corrugated cardboard, as well as the eventual cutting of a corrugated cardboard sheet (F) with the corrugated cardboard not advancing.

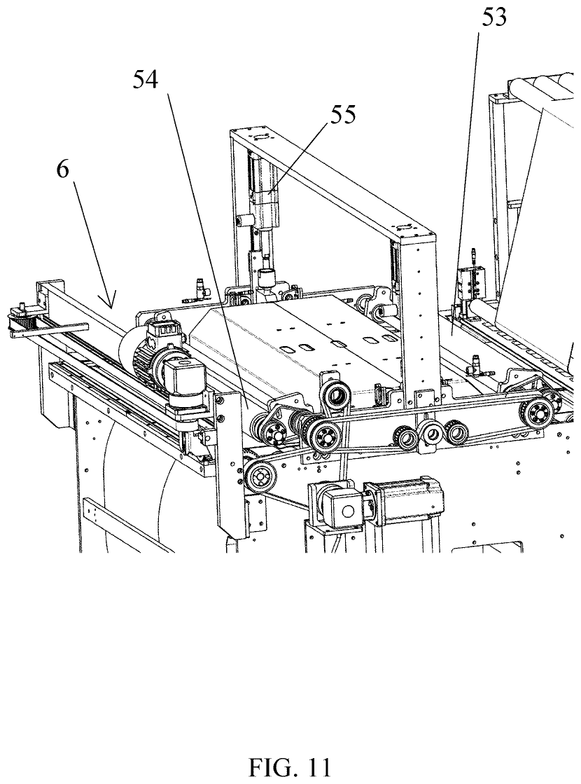

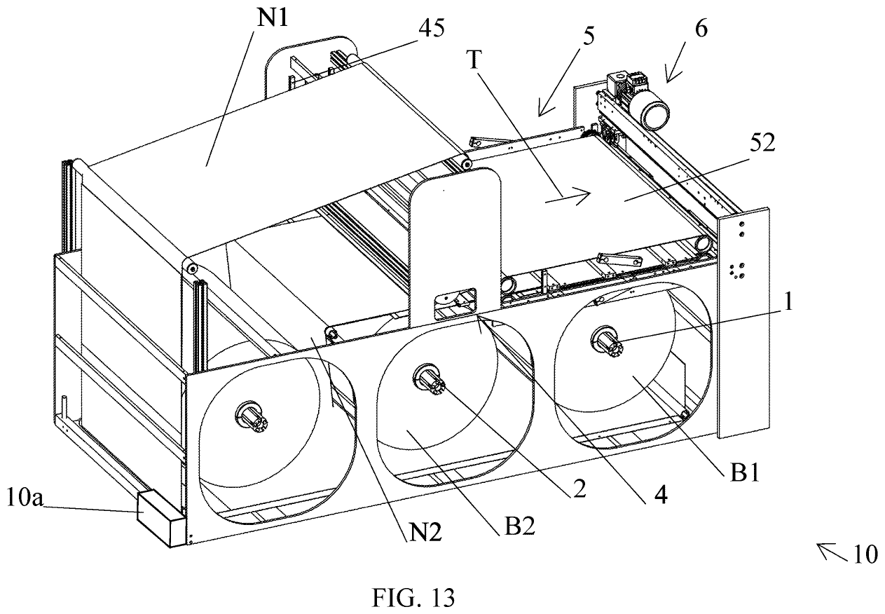

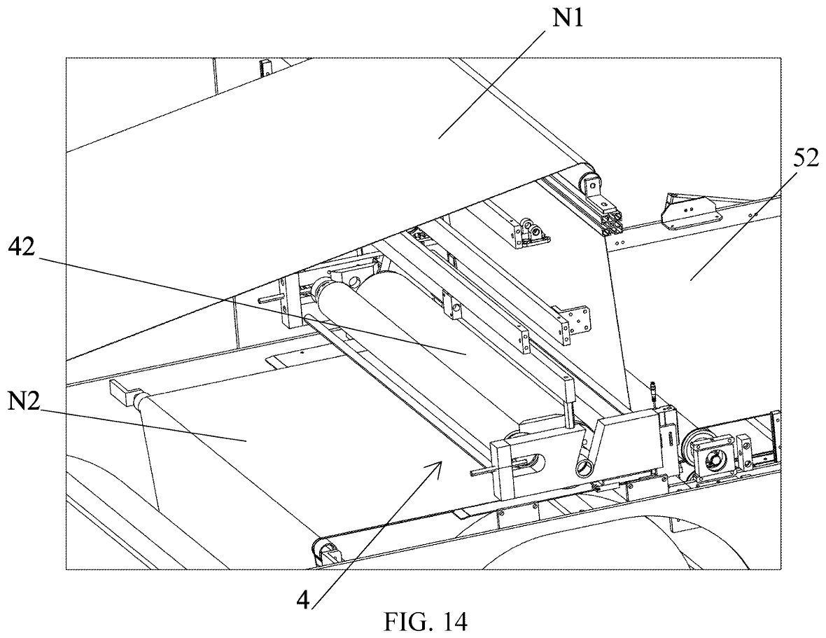

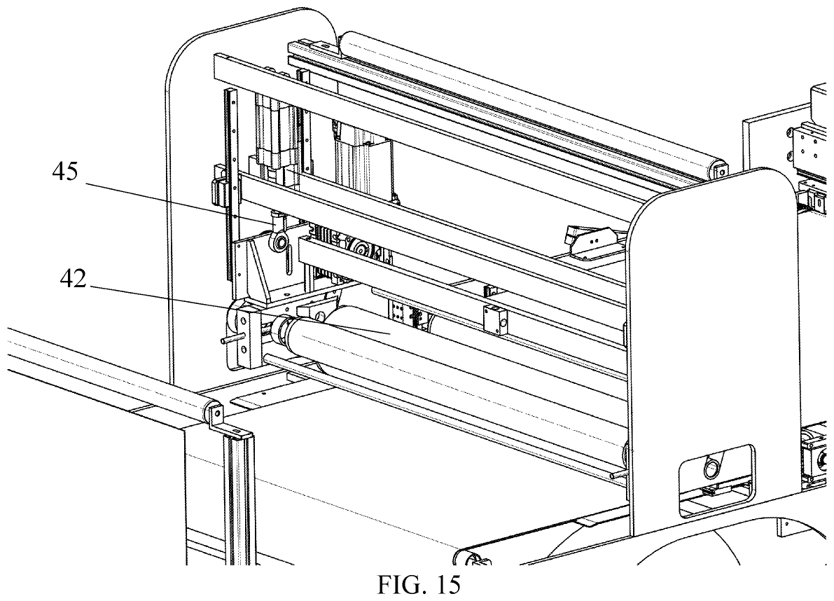

FIG. 11 illustrates the activations of another embodiment which, however, might also be used for the embodiments of FIG. 4, of FIG. 9, of FIG. 13 and of FIG. 17. It is known how these activations enable the same velocity of drawing between the first press belt (51) and the second press belt (52) or between the first press belt (51), the first press roller (53) the second press roller (54).

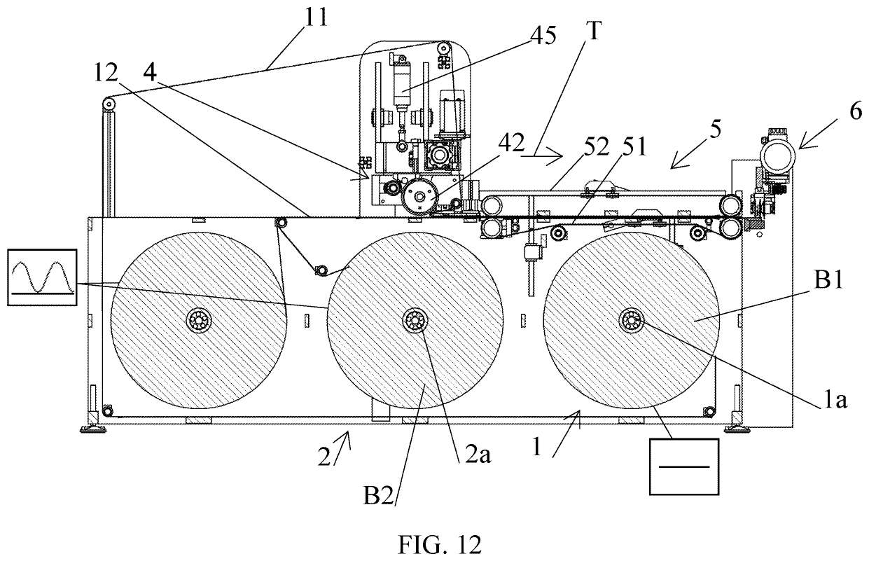

As FIGS. 16 and 17, as well as FIGS. 12 and 13, illustrate, the layout of the first strip (N1), of the second strip (N2) and of the third strip (N3) represent, respectively, the first path (11), the second path (12) and the third path (13), and therefore the references are substantially interchangeable.

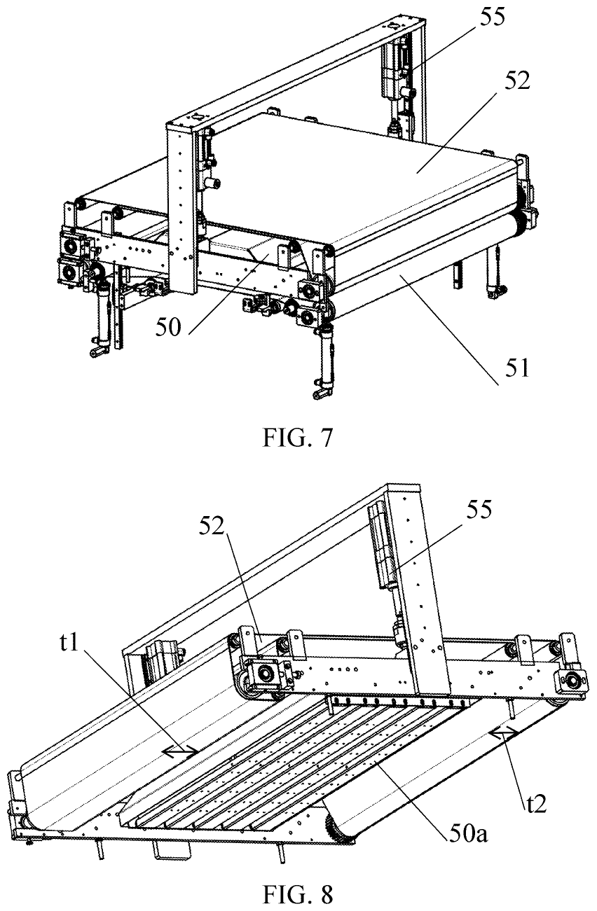

As shown in FIGS. 8 and 9, the second press belt (52) can follow a path which enables the introduction of the heater (50) while maintaining the pressure and the drawing in a first portion (t1) and in a second portion (t2).

As illustrated by way of example in FIG. 10, the same effect is obtained using a first press roller (53) and a second press roller (54) spaced apart from one another in the drawing direction (T). FIG. 10 shows the regulation of the distance between the first press belt (51) and the first press roller (53) and the second press roller (54); the rollers are hinged to the frame and set in rotation by actuators, two for each roller in the example case of FIG. 10.

The machine (10) preferably comprises:
a heater (50) which is located above the first press belt (51) and directly faces onto the first press belt (51) so that the heater (50) faces directly onto the strip, between the first strip (N1) and the second strip (N2), which does not contact the first press belt (51), i.e. on the first strip (N1) in the example of FIG. 4; and/or, preferably and,
a movement device (55) which vertically moves the heater (50) away from or towards the first press belt (51).

Though the use of heating means together with presses of known type is known, the configuration taught herein of a heater (50) above a first press belt (51) and located between the first press belt (51) and the second press belt (52) or between the first press roller (53) the second press roller (54) brings numerous benefits to the machine (10).

The heating between a first portion (t1) and a second portion (t2) of pressure, whether obtained with the second press belt (52) or with the first press roller (53) and the second press roller (53), improves the quality of the corrugated cardboard produced downstream of the stop and restart of the press (5) for example by enabling a greater distribution of the glue (A).

A more rapid drying of the glue (A) can be obtained, especially if of the vinyl type, enabling a greater production velocity, and/or smaller dimensions.

A reinvigoration of the adhesive properties of the glue (A) can be obtained, especially in the event of the use of glues known as hot-melt glues (A). In particular owing to the configuration described above, it is possible to reactivate the adhesive properties in areas where, owing to the production stop, the glue (A) has dried without the first strip (N1) and the second strip (N2) entering into mutual contact.

To this series of advantages there corresponds a drawback due to the overheating of the first strip (N1) and the second strip (N2), as well as of the components of the machine (10), at the moment of the stop. In particular it is very difficult to completely interrupt the heat flow with the risk of lowering the quality or damaging the corrugated cardboard in outlet. It is therefore preferable to have a movement device (55) which by moving the heater (50) away from the first strip (N1) and the second strip (N2) reduces or eliminates the negative effects illustrated in the foregoing.

More preferably, the control unit (10a) controls the movement device (55) and is configured to activate the movement device (55) between the stop and the restart.

According to a second configuration the control unit (10a) distinguishes between brief stops, which do not require the movement of the heater (50), and stops that, on the other hand, require the movement. For example, the control unit (10a) can be configured with a maximum waiting time. Should the maximum waiting time be exceed or it is expected that it will be exceeded, the control unit (10a) determines the moving away and therefore the following nearing before the restart of the drawing.

According to a further configuration, the control unit (10a) can each time command the movement of the heater (50). For example if there were present, downstream of a machine for boxing or packaging articles (P) that realised a box every 3 seconds, within this time interval, there could take place the drawing, the moving away, the moving towards and, possibly, the cutting by the cutter (6).

The choice of the configuration can also depend on the type of corrugated cardboard being processed and on the type of glue, as well as the working temperatures.

As shown by way of the embodiments of FIGS. 4, 9 and 10, the second press belt (52) preferably cooperates with the first press belt (51) for a first portion (t1) and for a second portion (t2) spaced apart from one another in the drawing direction (T) and the heater (50) is located between the first portion (t1) and the second portion (t2) or the heater (50) is located between the first press roller (53) and the second press roller (54), thus equally determining two portions that are spaced apart from one another.

The prototypes realised show how these configurations improve the quality of the corrugated cardboard manufactured.

The heater (50) preferably comprises a plurality of heating strips (50a) as illustrated by way of example in FIG. 8. The heating strips (50a) are preferably perforated.

Figures from 7 to 9 are examples of how the movement device (55) might be made in accordance with several modalities. In a preferred embodiment, the movement device (55) comprises a bridge above the press which is fixed to the frame and which bears one or more actuators, in the case of FIGS. 7 and 8 two linear actuators, which at an end are connected to the heater (50) so as to move it. In a further embodiment, illustrated by way of example in FIG. 9, it is possible to exploit the vertical movement of the second press belt (52) which can be used to define the distance with the first press belt (51). For example, FIG. 7 illustrates three of the four actuators that lift the second press belt (52) with respect to the first press belt (51). By fixing the heater (50) to the frame of the second press belt (52) it is possible to obtain the movement illustrated in FIG. 9 and, obviously, the return into the proximal position.

The movement of the second press belt (52) together with the heater (50) is possible owing to the presence of a second press, visible on the right in FIG. 9, which limits the impact of the detachment between the first press belt (51) and the second press belt (52). The different movement made in the embodiments of FIGS. 7 to 10 allows the reduction of the length of the machine (10) with respect to the embodiment of FIG. 9, do not require the presence of a second press and can enable obtaining a corrugated cardboard of better quality.

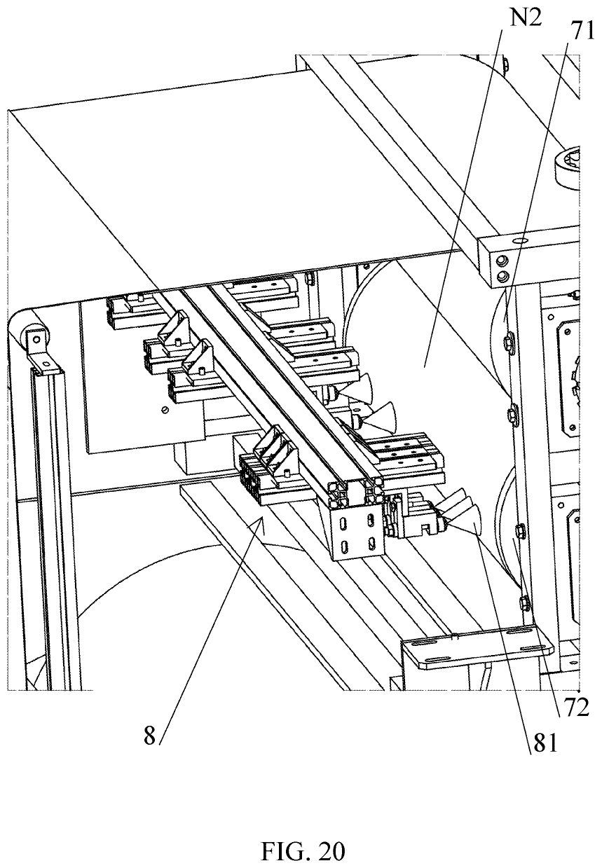

The machine (10) of the invention enables use of different types of glue dispensers (4). By way of example, the embodiment of FIG. 4 illustrates the use of a spreader (44) for depositing hot melt adhesive (A), the embodiment of FIG. 13 shows the use of a depositing roller (42) and the embodiment of FIG. 20 shows the use of nozzles (41) for spraying.

The machine (10) preferably comprises a movement apparatus (45) and further:
the glue dispenser (4) comprises a depositing roller (42) for depositing glue (A);
the movement apparatus (45) moves the depositing roller (42) between an operating position in which it deposits glue (A) and a rest position, more distanced from the path of the strip on which it deposits the glue (A);
the control unit (10a) controls the movement apparatus (45) and is configured to activate the movement apparatus (45) so as to move the depositing roller (42) into the rest position, for example, should the restart not take place, or should it not be included, after a maximum wait from the stop has timed out; the maximum wait might be of a few tenths of a second. The control unit (10a) might be configured such as to activate the movement apparatus (45) at each stop, i.e. one of the two above-described configurations for the movement device (55) might also be replicated for the movement apparatus (45).

As already evidenced, the glue dispenser (4) can be configured to deposit vinyl glue or be configured to deposit a hot melt adhesive.

In the sector of reference, the use of roller glue dispensers is known, for example such as those illustrated in FIG. 12 and FIG. 16: the depositing roller (42) of the glue dispenser (4) or the depositing roller (82) of a second glue dispenser (8), introduced in the following, typically receives the glue (A) from another respective roller immersed in a tank, generally of glue, preferably of a vinyl type.

If the glue dispenser (4) utilises a glue depositing roller (42), a corrugated cardboard of better quality is obtained by depositing the glue (A) on the crests of the second strip (N2). The same considerations can be applied to the second glue dispenser (8), in a case where it comprises a depositing roller (82).

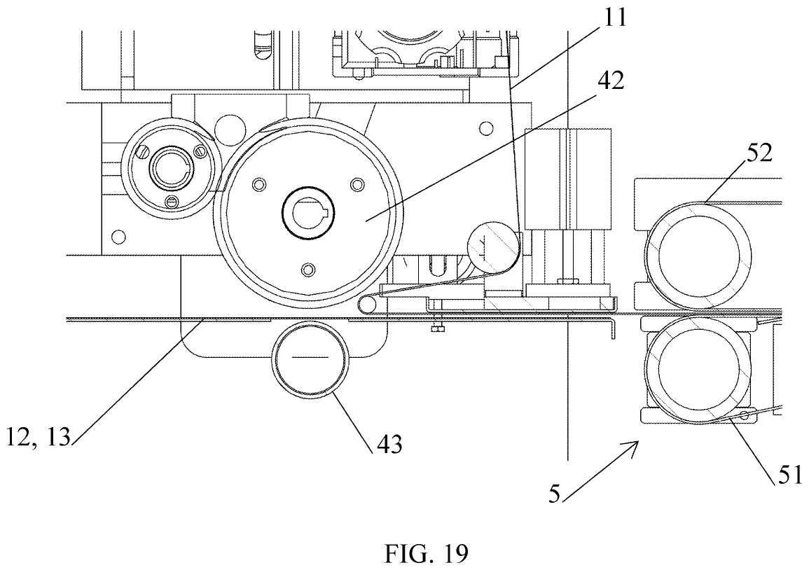

The machine (10) preferably comprises a counter-roller (43) at the depositing roller (42) of the glue dispenser (4) which facilitates the deposition of the glue (A) on the crests of the second strip (N2), as illustrated in FIG. 19. Also visible in FIG. 19 is the passage of the first strip (N1), of the second strip (N2) and of the third strip (N3) between two plates located downstream of the counter-roller (43) and before the press (5).

The installation of a spray glue dispenser (4) instead of a roller dispenser enormously simplifies the use of the machine (10) and the machinery (1000) as it offers a simpler management of the glue (A) while awaiting use which, in a roller glue dispenser (4), is collected in the tank in which the other respective roller is immersed. Differently, a spray glue dispenser (4) collects, time by time, from a tank substantially the quantity of glue (A) in use, reducing the risk of deterioration of the glue (A), or clogging, or the presence of lumps. Like considerations are true for the spreader (44) which deposits hot melt adhesive (A).

This is extremely significant for the aims of the invention.

The glue dispenser (4) preferably comprises nozzles (41) for spraying glue (A), configured so as to spray glue (A) on a side of a cardboard strip.

The second glue dispenser (8) is also preferably of the spray type; the second glue dispenser (8) preferably comprises nozzles (81) for spraying glue (A), configured so as to spray glue (A) on a side of a cardboard strip.

The nozzles (41) of the glue dispenser (4) or the nozzles (81) of the second glue dispenser (8) can spray glue or other adhesives, for example hot melt glues, without contacting the strip.

Figures from 20 to 23 illustrate variants of the machine (10) of FIG. 17 which use spray glue dispensers. Though the spray glue dispensers can apply the glue (A) either on a corrugated or smooth strip, some testing has shown that often a better product is obtained by applying the glue (A) on a smooth strip. In fact, when the glue (A) is sprayed on the corrugated strip, some parts of glue (A) are spread on the gullies between the crests and create incrustations and/or lack of homogeneity which, instead, these are not generated when spraying on a smooth strip.

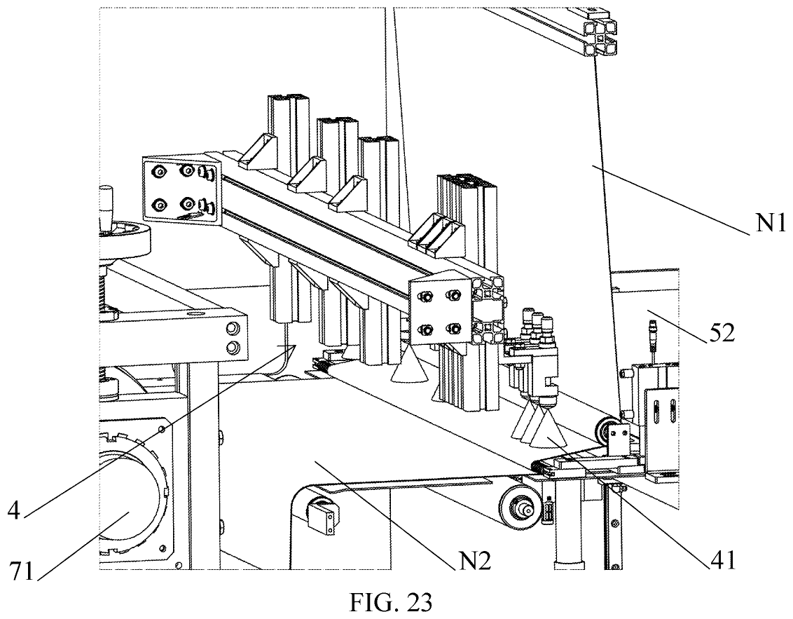

As illustrated by way of example in FIG. 23, the glue dispenser (4) preferably comprises nozzles (41) and the first path (11) crosses the glue dispenser (4) so that the glue dispenser (4), at least in an active condition, deposits glue (A) on the first strip (N1).

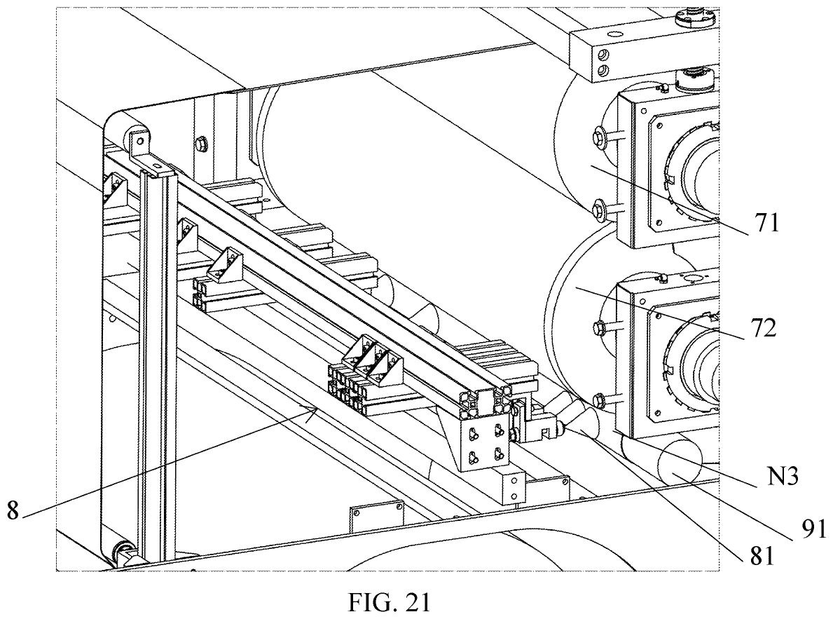

As illustrated by way of example in FIG. 21, the second glue dispenser (8) preferably comprises nozzles (81) and the third path (31) crosses the second glue dispenser (8) so that the second glue dispenser (8) deposits glue (A) on the third strip (N3).

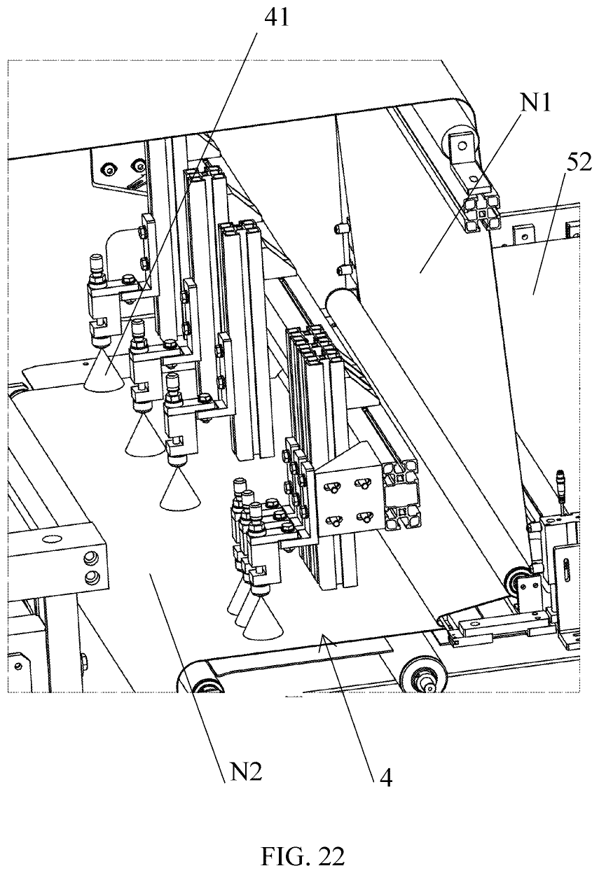

However, as is shown in FIGS. 20 and 22:
the second glue dispenser (8) can comprise nozzles (81) and the second path (12) crosses the second glue dispenser (8) so that the second glue dispenser (8) deposits the glue (A) on the second strip (N2) and/or
the glue dispenser (4) can comprise nozzles (41) and the first path crosses the glue dispenser (4) so that the glue dispenser (4) deposits the glue (A) on the second strip (N2).

FIG. 4 shows, by way of example, a spreader (44) of hot melt adhesive (A).

The various types of glue dispenser (4) are mutually interchangeable, though with relative advantages and defects, as some embodiments operate better with one type of glue (A) rather than with others. For example, the variants of FIGS. 22 and 23 are also applicable in the embodiment of FIG. 13.

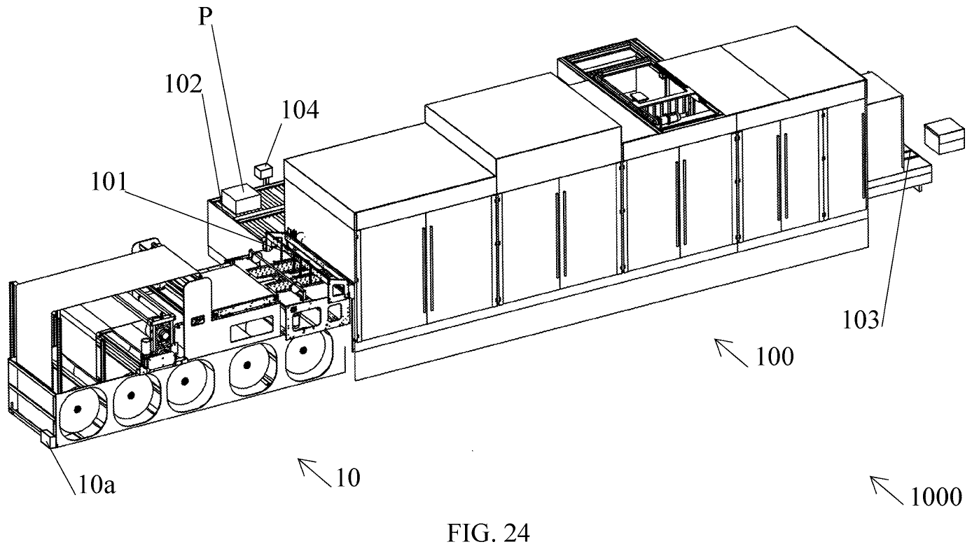

The present text describes and gives examples of two main versions of the machine (10): the first is visible, in particular, in FIGS. 17 and 24 while the second is visible, in particular, in FIGS. 4, 13 and 25. The first main version enables production of single-wall corrugated cardboard, or even with single-face corrugated cardboard if the first path (11) and the glue dispenser (4) are deactivated, starting from reels of smooth cardboard. The second main version, also known as a coupler, enables production of single-wall corrugated cardboard starting from a reel of smooth cardboard and from a reel of single-face corrugated cardboard or with single-face corrugated cardboard starting from a reel of smooth cardboard and from a reel of corrugated cardboard.

The main first version of the machine (10) further comprises:
a third reel unwinder (3) for unwinding a third strip (N3) from a third reel (B3) of cardboard;
a corrugator (7) for corrugating a cardboard strip;
a second glue dispenser (8) for depositing glue (A) on a side of cardboard strip;
means for pressing (9) cardboard strips to one another;
a third path (13) of the third strip (N3) which, going from the third unwinder (3), reaches the press (5).

The second path (12) crosses the corrugator (7) so that the corrugator (7) makes the corrugations on the second corrugated strip (N2).

A path, between the second path (12) and the third path (13), crosses the second glue dispenser (8) so that the second glue dispenser (8) deposits glue (A) on the second strip (N2) or on the third strip (N3).

The second path (12) and the third path (13) meet before or at the means for pressing (9) so that the glue (A) is interposed between the second strip (N2) and the third strip (N3).

The press (5), especially the above-described elements, is configured to press and draw together the first strip (N1), the second strip (N2) and the third strip (N3) thus forming corrugated cardboard.

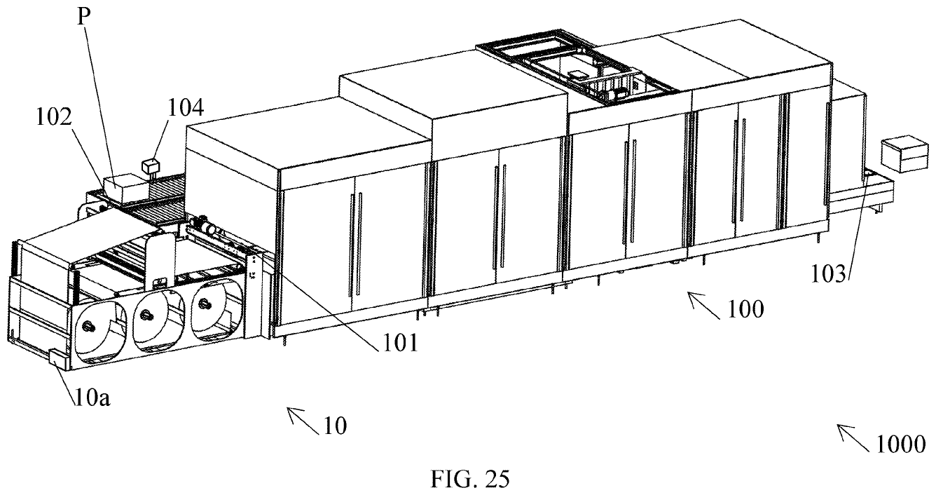

The machine (10) of the invention shown by way of example in FIG. 17 can realise the two types of corrugated cardboard most commonly requested and which can be used to produce other types of corrugated cardboard, i.e: single-wall corrugated cardboard, typically require in sheets of corrugated cardboard sheets (F), and single-face corrugated cardboard. These productions can take place in proximity of the following use, typically in a system comprising one or more machineries for boxing or packaging articles using corrugated cardboard, as is shown in FIGS. 24 and 25.

The corrugator (7) preferably comprises a first corrugator roller (71) and a second corrugator roller (72) and the latter is aspirated. The means for pressing (9) comprise a roller (91) which cooperates with the second corrugator roller (72) to press the second strip (N2) and the third strip (N3) so that, at least initially, the coupling takes place with the second strip (N2) retained, by suction, by the second corrugator roller (72).

In this way it is possible to obtain a more defined and precise coupling between the second strip (N2) and the third strip (N3).

Generally one or both, typically both, the first corrugator roller (71) and the second corrugator roller (72) are heated. The absence of heating can negatively influence not only the corrugation of the second strip (N2) but also the action of the glue (A).

The arrangement shown by way of example in FIG. 16 enables limiting the length of the machine (10) and arranging the first reel (B1), the second reel (B2) and the third reel (B3) in proximity of the ground surface, simplifying the loading and unloading operations, as well as the start.

The first unwinder (1), the second unwinder (2) and the third unwinder (3) are preferably arranged adjacent to one another so that the respective reels (B1, B2; B3) occupy a volume (V) and the corrugator (7), the glue dispenser (4) and the second glue dispenser (8) are arranged so as to insist on the volume (V), i.e. they are on the opposite side of the volume (V) with respect to the ground surface, as illustrated by way of example in FIG. 16.

FIG. 12, like FIG. 4, illustrates a further unwinder which can operate as a replacement for the second unwinder (2), typically so as to take account of the more rapid consumption of the second reel (B2) with respect to the first reel (B1). In this case it is preferable for the first unwinder (1), the second unwinder (2) and the further unwinder to be arranged adjacent to one another so that the respective reels (B1, B2) occupy a first volume and the glue dispenser (4) and the press (5) are arranged so as to insist on the first volume, i.e. they are on the opposite side of the first volume (V) with respect to the ground surface, as illustrated by way of example in FIG. 4.

As can be observed in the illustrative rectangles shown in FIG. 16, typically the first reel (B1) of cardboard, the second reel (B2) of cardboard and the third reel (B3) of cardboard are made of smooth cardboard; these are smaller, given a same unwinding, that a reel of single-face corrugated cardboard and have a lower cost.

The machine (10) of the invention has a limited size, for example the embodiment of FIG. 17 can occupy a space comprised between 5 and 10 metres, typically about 6.5 metres. However the machine (10), as illustrated in the embodiment of FIG. 4, might not comprise an aspirated conveyor belt (10b) between the press (5) and the cutter (6) and be still more compact, up to or nearly up to the sum of the diameters of the first reel (B1), the second reel (B2) and the further reel, as substantially occurs in the case of FIG. 4 or of FIG. 12. The presence of a heater (50), as in FIG. 4, facilitates the reduction of the length of the machine (10).

The machine (10), which thus can be a machine for supplying corrugated cardboard sheets (F), preferably comprises a cutter (6) for cutting corrugated cardboard strips so as to obtain corrugated cardboard sheets (F) and the control unit (10a) controls the cutter (6) so that the cutter (6) cuts cardboard sheets (F) of a desired length (L) with the press (5) stopped.

In this way the machine (10) for realising corrugated cardboard sheets (F), typically of single-wall corrugated cardboard, on request and according to needs, thus facilitating the provision of machinery for boxing or packaging articles (P) using corrugated cardboard.

The accompanying figures show a cutter (6) comprising a movable blade according to a path that is transversal to the drawing direction (T). However, other cutters (6) of known type could be used, for example comprising a vertically movable blade that cooperates with a counterblade.

According to the level of integration of the machine (10) with the machines (100) downstream, the cutter (6) might not be present and might be integrated in a machine downstream, as illustrated below in relation to the machinery (1000).

Numerous variants of control unit (10a) are known, for example the control unit (10a) might comprise a programmable logic controller or a single board computer or a more complex industrial control system.

The first unwinder (1) preferably comprises a motor for unwinding the first reel (B1) of cardboard and the control unit (10a) controls the motor of the first unwinder (1) on the basis of the value of the desired length.

For example, FIG. 16 illustrates a motorised roller (1a) of the first unwinder (1). Likewise, also the second unwinder (2) and the third unwinder (3) can comprise a motor for respectively unwinding the second reel (B2) of cardboard and the third reel (B3) of cardboard. For example, FIG. 16 illustrates a motorised roller (2a) of the second unwinder (2) and a motorised roller (3a) of the third unwinder (3).

The control unit (10a) preferably also controls the motor of the second unwinder (2) and, possibly, of the third unwinder (3) on the basis of value of the desired length.

The invention also relates to machinery (1000) for boxing or packaging articles (P) using corrugated cardboard.

An embodiment of the machinery (1000) comprises:
a machine (10) for supplying corrugated cardboard according to the present description;
a machine (100) for boxing or packaging articles (P) which comprises a corrugated cardboard inlet (101).

The corrugated cardboard inlet (101) is arranged downstream of the machine (10) for supplying corrugated cardboard so as to receive corrugated cardboard.

The machinery (1000) of the invention does not require reels of single-wall corrugated cardboard, stacks of corrugated cardboard sheets (F), or fanfolds, or other types but directly receives the strips or sheets of corrugated cardboard (F) in outlet from a machine (10) for supplying corrugated cardboard. The machine is therefore at the direct service of the machine (100) for boxing or packaging articles (P).

Various machines (100) for boxing or packaging articles (P) are known, for example realised according to one or more of documents EP3947167A1, EP3464074A1, EP4117995A1,EP3947166A1, WO2023002396A1 and EP4157726A1 which, according to the specific standards requirements are referred-to and/or incorporated in the present description. The expert in the sector will understand how a corrugated cardboard sheet (F) can replace a sheet obtained by cutting a fanfold or corrugated cardboard sheets (F) joined to one another can replace a strip or a blank can be obtained by appropriated profiling a corrugated cardboard sheet (F).

By way of example, the machinery (1000) represented in FIGS. 24 and 25 uses the machine (100) for boxing or packaging articles (P) illustrated in EP3947167A1 after the cutter represented in FIG. 3 of EP3947167A1, as the machine (10) for supplying corrugated cardboard, illustrated in the same figures, already produces corrugated cardboard sheets (F).

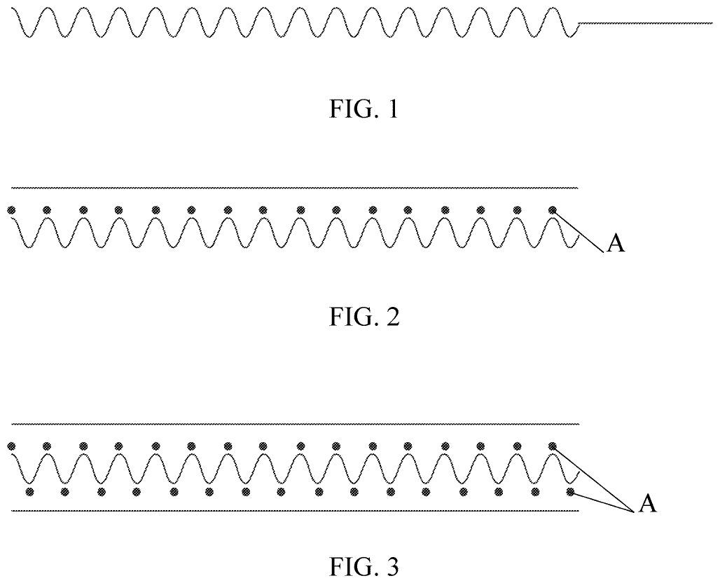

Again by way of example, the machine (10) for supplying corrugated cardboard can replace the reel visible in FIG. 1 of EP4157726A1. In this case it can, more advantageously, produce a corrugated cardboard strip, preferably of the single-face type.

The machinery (1000) simplifies the provision of the reels, in particular avoiding the use of reels of corrugated cardboard or, possibly limiting the use of single-face corrugated cardboard. The storing of reels of smooth cardboard in place of corrugated, also reduces the volumes in the store, and can lead to economic savings.

In a case where the machine (10) does not comprise a cutter (6), it is preferable for the machinery (1000) to comprise a dedicated cutter for cutting corrugated cardboard strips so as to obtain corrugated cardboard sheets (F), which can be entirely alike to the cutter (6), or in any case of known type. The control unit (10a) controls the dedicated cutter so that the cutter cuts cardboard sheets having a desired length (L) with the press (5) stopped.

If the cutter (6) is present, it is preferable for the corrugated cardboard inlet (101) to be arranged adjacent to the cutter (6) in such a way that the corrugated cardboard crosses the corrugated cardboard inlet (101) before the cutter (6) has cut the corrugated cardboard sheet (F) or the successive corrugated cardboard sheet (F), more preferably before the cutter has cut the corrugated cardboard sheet (F).

The machinery (1000) described in the foregoing can produce boxes or customised packages, thus reducing the volume of the packages and/or the consumption of material, as will be more fully explained in the following.

The machine (10) for supplying corrugated cardboard and the machine (100) for boxing or packaging articles (P) are preferably in contact.

Thus the overall size of the machinery (1000) is reduced and it is not necessary to transport the strips or the corrugated cardboard sheets (F) on a longer path, which might damage them. This may well occur if the glue (A) is not completely spread or has dried.

Note that the realising of the packaging or the box, or the packaging or the box obtained, might draw advantage from a corrugated cardboard with the glue (A) not completely spread or dried and which spreads or dries after it has been deformed and has reached the final shape to protect the one or more articles (P).

The machine (100) for boxing or packaging articles (P) preferably comprises means for defining the desired length of a corrugated cardboard sheet (F) in inlet on the basis of one or more articles (P) to be boxed or packaged; the means for defining send successive values of the desired length to the control unit (10a).

As indicated above, the machinery (1000) of the invention enables considerable customisation in the production of boxes and packaging, reducing the volumes and the material used. Numerous means are known to define, starting from computer programs or software which estimate the desired length on the basis of the dimensions of the one or more articles to be boxed or packaged. Also known are scanning or sensor means which can measure or determine the dimensions of one or more articles (P) together.

FIGS. 24 and 25 show an example of a scanner (104).

The machinery (1000) also comprises an articles inlet (102) and an articles outlet when boxed or packaged (103).

The invention also relates to a method for providing single-wall sheets of corrugated cardboard (F) to a machine (100) for boxing or packaging articles (P).

An embodiment of the method comprises steps of:
providing a machine (10) for supplying corrugated cardboard according to the present description;
supplying a first strip (N1) of smooth cardboard;
providing a second strip (N2) of single-face corrugated cardboard;
receiving a first value of a desired length of a corrugated cardboard sheet (F);
starting the press (5), starting the first press belt (51) and the second press belt (52) or starting the first press belt (51), the first press roller (53) and the second press roller (54);
stopping the press (5), stopping the first press belt (51) and the second press belt (52) or stopping the first press belt (51), the first press roller (53) the second press roller (54) after the first strip (N1) and the second strip (N2) have been advanced in the drawing direction (T) for a distance equal to the first value;
cutting the corrugated cardboard in outlet from the press (5) so as to obtain a single-wall cardboard sheet (F).

The above-described method enables obtaining the advantages already mentioned in the foregoing in terms of the quality of the product obtained and the production flexibility.

During the step of providing a gear box (10), the machine (10) preferably comprises:
a heater (50) which is located above the first press belt (51) and directly faces onto the first press belt (51) so that the heater (50) directly faces onto the first strip (N1) or onto the second strip (N2) and
a movement device (55) which moves the heater (50) vertically away from or towards the first press belt (51).

Further, following the step of stopping the press (5), the method comprises steps of:
activating the movement device (55) so as to move the heater (50) from the first press belt (51);
receiving a second value of the desired length of a corrugated cardboard sheet (F);
newly activating the movement device (55) so as to near the heater (50) to the first press belt (51);
newly starting the press (5), starting the first press belt (51) and the second press belt (52) or starting the first press belt (51), the first press roller (53) and the second press roller (54);
newly stopping the press (5) stopping the first press belt (51) and the second press belt (52) or stopping the first press belt (51), the first press roller (53) and the second press roller (54) after the first strip (N1) and the second strip (N2) are advanced in the drawing direction (T) for a distance equal to the second value.

It is therefore possible to obtain a second single-wall corrugated cardboard sheet, after an appropriate cut, without the wait having a negative influence on the quality of production, on the integrity of the products, on the integrity of the components or on the operativity of the machine (10) on forming corrugated cardboard.

During the step of providing a machine (10), the machine (10) preferably comprises a movement apparatus (45) and the glue dispenser (4) further comprises a depositing roller (42) for depositing glue (A), the movement apparatus (45) moving the depositing roller (42) between an operating position in which it deposits glue (A) and a rest position. Further, following the step of stopping the press (5), the method comprises steps of:
activating the movement apparatus (45) so as to move the depositing roller (42) into the rest position;
receiving a second value of the desired length of a corrugated cardboard sheet (F);
newly activating the movement apparatus (45) so as to move the depositing roller (42) into the operating position;
newly starting the press (5), starting the first press belt (51) and the second press belt (52) or starting the first press belt (51), the first press roller (53) and the second press roller (54);
newly stopping the press (5), stopping the first press belt (51) and the second press belt (52) or stopping the first press belt (51), the first press roller (53) and the second press roller (54) after the first strip (N1) and the second strip (N2) are advanced in the drawing direction (T) for a distance equal to the second value.

Clearly the movement apparatus (45) and the movement device (55) can co-exist so that the above-described steps can be integrated between a stop and a restart.

The invention also relates to a method for operating a machinery (1000) for boxing or packaging articles (P) using corrugated cardboard.

An embodiment of the method comprises steps of:
providing one or more articles (P);
providing a cutter (6) for cutting corrugated cardboard strips so as to obtain corrugated cardboard sheets (F);
providing a machinery (1000) for boxing or packaging articles (P) using corrugated cardboard according to the present description and in which the control unit (10a) controls the cutter (6) so that the cutter (6) cuts corrugated cardboard sheets (F) having a desired length (L) with the press (5) stopped;
determining at least one dimension of a box or a packaging made of corrugated cardboard for containing or winding the one or more articles (P);
defining a value of the desired length of a corrugated cardboard sheet (F) on the basis of at least one dimension;
transmitting the value to the control unit (10a).

The method of the invention enables considerable customisation in the production of boxes and packaging, reducing the volumes and the material used.

The above-described steps connected to the presence of a movement device (55) and/or a movement apparatus (45), in the presence of these components, can be integrated in the method for operating machinery (1000), with the advantages as illustrated in the foregoing.

It is understood that the above has been described by way of non-limiting example and that any constructional variants are considered to fall within the protective scope of the present technical solution, as claimed in the following.

1) A machine for supplying corrugated cardboard to a machine for boxing or packaging articles comprising:
a first reel unwinder for unwinding a first strip from a first reel of cardboard;
a second reel unwinder for unwinding a second strip from a second reel of cardboard;
a glue dispenser for depositing glue on a side of cardboard strip;
a press for pressing strips and drawing strips according to a drawing direction which comprises a first press belt;
a first path of the first strip which, going from the first unwinder reaches the press;
a second path of the second strip which, going from the second unwinder, reaches the press; and
a control unit which controls the press
wherein:
the first path or the second path crosses the glue dispenser so that the glue dispenser deposits glue on the first strip or on the second strip;
the first path and the second path meet before or at the press so that the glue is interposed between the first strip and the second strip;
the press comprises a second press belt located above the first press belt or a first press roller and a second press roller which are positioned above the first press belt and which are spaced apart from one another in the drawing direction so that the first press belt and the second press belt or the first press belt and the first press roller and the first press belt and the second press roller press one another and together draw, in the drawing direction, the first strip and the second strip, thus forming corrugated cardboard; and
the control unit is configured to receive successive values of the desired length of corrugated cardboard and to stop and restart the first press belt and the second press belt or the first press belt, the first press roller and the second press roller each time a desired length of corrugated cardboard is supplied in outlet from the press.

2) The machine of claim 1, comprising:
a heater which is located above the first press belt and directly faces onto the first press belt so that the heater directly faces onto the first strip or onto the second strip; and
a movement device which vertically moves the heater away from or towards the first press belt

3) The machine of claim 2, wherein the control unit controls the movement device and is configured to activate the movement device between the stop and the restart.

4) The machine of claim 2, wherein the second press belt cooperates with the first press belt for a first portion and for a second portion spaced apart from one another in the drawing direction and the heater is located between the first portion and the second portion or wherein the heater is located between the first press roller and the second press roller.

5) The machine of claim 1, comprising a movement apparatus wherein:
the glue dispenser comprises a depositing roller for depositing glue;
the movement apparatus moves the depositing roller between an operating position in which it deposits glue and a rest position;
the control unit controls the movement apparatus and is configured to activate the movement apparatus so as to move the depositing roller into the rest position.

6) The machine of claim 1, wherein the glue dispenser is configured to deposit vinyl glue or is configured to deposit a hot melt adhesive.

7) The machine of claim 1, comprising:
a third reel unwinder for unwinding a third strip from a third reel of cardboard;
a corrugator for corrugating a cardboard strip;
a second glue dispenser for depositing glue on a side of cardboard strip;
means for pressing cardboard strips to one another; and
a third path of the third strip which, going from the third unwinder, reaches the press;
wherein:
the second path crosses the corrugator so that the corrugator corrugates the second corrugated strip;
the second path or the third path crosses the second glue dispenser so that the second glue dispenser deposits glue on the second strip or on the third strip;
the second path and the third path meet before or at the means for pressing so that the glue is interposed between the second strip and the third strip; and
the press is configured to draw together the first strip, the second strip and the third strip thus forming corrugated cardboard.

8) (canceled)

9) The machine of claim 1, comprising a cutter for cutting corrugated cardboard strips so as to obtain corrugated cardboard sheets, wherein the control unit controls the cutter so that the cutter cuts cardboard sheets having a desired length with the press stopped.

10) (canceled)

11) (canceled)

12) A method for supplying single wall sheets of corrugated cardboard sheets to a machine for boxing or packaging articles comprising steps of:
providing a machine for supplying corrugated cardboard comprising:
a first reel unwinder for unwinding a first strip from a first reel of cardboard,
a second reel unwinder for unwinding a second strip from a second reel of cardboard,
a glue dispenser for depositing glue on a side of cardboard strip.
a press for pressing strips and drawing strips according to a drawing direction which comprises a first press belt,
a first path of the first strip which, going from the first unwinder, reaches the press,
a second path of the second strip which, going from the second unwinder, reaches the press, and
a control unit which controls the press;
supplying a first strip of smooth cardboard;
supplying a second strip of single-face corrugated cardboard;
receiving a first value of the desired length of a corrugated cardboard sheet
starting the press, starting the first press belt and the second press belt or starting the first press belt, the first press roller and the second press roller;
stopping the press, stopping the first press belt and the second press belt or stopping the first press belt, the first press roller and the second press roller after the first strip and the second strip have been advanced in the drawing direction for a distance equal to the first value; and
cutting the corrugated cardboard in outlet from the press so as to obtain a single-wall cardboard sheet;
wherein:
the first path or the second path crosses the glue dispenser so that the glue dispenser deposits glue on the first strip or on the second strip;
the first path and the second path meet before or at the press so that the glue is interposed between the first strip and the second strip;
the press comprises a second press belt located above the first press belt or a first press roller and a second press roller which are positioned above the first press belt and which are spaced apart from one another in the drawing direction so that the first press belt and the second press belt or the first press belt and the first press roller and the first press belt and the second press roller press one another and together draw, in the drawing direction, the first strip and the second strip, thus forming corrugated cardboard; and
the control unit is configured to receive successive values of the desired length of corrugated cardboard and to stop and restart the first press belt and the second press belt or the first press belt, the first press roller and the second press roller each time a desired length of corrugated cardboard is supplied in outlet from the press.

13) The method of claim 12 wherein in the step of providing a machine the machine for supplying corrugated cardboard comprises a heater which is located above the first press belt and directly faces onto the first press belt so that the heater directly faces onto the first strip or onto the second strip and a movement device which moves the heater vertically away from or towards the first press belt and wherein following the step of stopping the press the method comprises steps of:
activating the movement device so as to move the heater from the first press belt;
receiving a second value of the desired length of a corrugated cardboard sheet
newly activating the movement device so as to near the heater to the first press belt;
newly starting the press starting the first press belt and the second press belt or starting the first press belt, the first press roller and the second press roller; and
newly stopping the press, stopping the first press belt and the second press belt or stopping the first press belt, the first press roller and the second press roller after the first strip and the second strip have advanced in the drawing direction for a distance equal to the second value.

14) The method of claim 12 wherein in the step of providing a machine the machine for supplying corrugated cardboard comprises a movement apparatus, the glue dispenser comprises a depositing roller for depositing glue. the movement apparatus moves the depositing roller between an operating position in which it deposits glue and a rest position and the control unit controls the movement apparatus and is configured to activate the movement apparatus so as to move the depositing roller into the rest position and wherein, following the step of stopping the press, the method comprises steps of:
activating the movement apparatus so as to move the depositing roller into the rest position;
receiving a second value of the desired length of a corrugated cardboard sheet;
newly activating the movement apparatus so as to move the depositing roller into the operating position;
newly starting the press starting the first press belt and the second press belt or starting the first press belt, the first press roller and the second press roller; and
newly stopping the press stopping the first press belt and the second press belt or stopping the first press belt, the first press roller and the second press roller after the first strip and the second strip have advanced in the drawing direction for a distance equal to the second value.

15) (canceled)

16) The machine of claim 3, wherein the second press belt cooperates with the first press belt for a first portion and for a second portion spaced apart from one another in the drawing direction and the heater is located between the first portion and the second portion or wherein the heater is located between the first press roller and the second press roller.

17) Machinery for boxing or packaging articles using corrugated cardboard, comprising:
a machine for supplying corrugated cardboard comprising:
a first reel unwinder for unwinding a first strip from a first reel of cardboard,
a second reel unwinder for unwinding a second strip from a second reel of cardboard,
a glue dispenser for depositing glue on a side of cardboard strip,
a press for pressing strips and drawing strips according to a drawing direction which comprises a first press belt,
a first path of the first strip which, going from the first unwinder, reaches the press,
a second path of the second strip which, going from the second unwinder, reaches the press, and
a control unit which controls the press; and
a machine for boxing or packaging articles which comprises a corrugated cardboard inlet;
wherein:
the first path or the second path crosses the glue dispenser so that the glue dispenser deposits glue on the first strip or on the second strip;
the first path and the second path meet before or at the press so that the glue is interposed between the first strip and the second strip;
the press comprises a second press belt located above the first press belt or a first press roller and a second press roller which are positioned above the first press belt and which are spaced apart from one another in the drawing direction so that the first press belt and the second press belt or the first press belt and the first press roller and the first press belt and the second press roller press one another and together draw, in the drawing direction, the first strip and the second strip, thus forming corrugated cardboard;
the control unit is configured to receive successive values of the desired length of corrugated cardboard and to stop and restart the first press belt and the second press belt or the first press belt, the first press roller and the second press roller each time a desired length of corrugated cardboard is supplied in outlet from the press; and
the corrugated cardboard inlet is arranged downstream of the machine for supplying corrugated cardboard so as to receive corrugated cardboard.

18) The machinery of claim 17, comprising a dedicated cutter for cutting corrugated cardboard strips so as to obtain corrugated cardboard sheets, wherein the control unit controls the dedicated cutter so that the dedicated cutter cuts the cardboard sheets having the desired length with the press stopped.

19) The machinery of claim 17, wherein the machine comprises a cutter for cutting corrugated cardboard strips so as to obtain corrugated cardboard sheets, wherein the control unit controls the cutter so that the cutter cuts cardboard sheets having a desired length with the press stopped and wherein the corrugated cardboard inlet is arranged adjacent to the cutter in such a way that the corrugated cardboard crosses the corrugated cardboard inlet before the cutter has cut the corrugated cardboard sheet or the successive corrugated cardboard sheet.

20) The machinery of claim 17, wherein the machine for supplying corrugated cardboard comprises:
a heater which is located above the first press belt and directly faces onto the first press belt so that the heater directly faces onto the first strip or onto the second strip; and
a movement device which vertically moves the heater away from or towards the first press belt.

21) The machinery of claim 20, wherein the control unit controls the movement device and is configured to activate the movement device between the stop and the restart.

22) The machinery of claim 20, wherein the second press belt cooperates with the first press belt for a first portion and for a second portion spaced apart from one another in the drawing direction and the heater is located between the first portion and the second portion or wherein the heater is located between the first press roller and the second press roller.

23) The machinery of claim 17, comprising a movement apparatus wherein:
the glue dispenser comprises a depositing roller for depositing glue;
the movement apparatus moves the depositing roller between an operating position in which it deposits glue and a rest position; and
the control unit controls the movement apparatus and is configured to activate the movement apparatus so as to move the depositing roller into the rest position.

24) The machinery of claim 17, wherein the machine for supplying corrugated cardboard comprises
a third reel unwinder for unwinding a third strip from a third reel of cardboard;
a corrugator for corrugating a cardboard strip;
a second glue dispenser for depositing glue on a side of cardboard strip;
means for pressing cardboard strips to one another; and
a third path of the third strip which, going from the third unwinder, reaches the press;
wherein:
the second path crosses the corrugator so that the corrugator corrugates the second corrugated strip;
the second path or the third path crosses the second glue dispenser so that the second glue dispenser deposits glue on the second strip or on the third strip;
the second path and the third path meet before or at the means for pressing so that the glue is interposed between the second strip and the third strip; and
the press is configured to draw together the first strip, the second strip and the third strip thus forming corrugated cardboard.
